(19) United States
(12) Patent Application Publication
(10) Pub. No.: US 2006/0183854 A1
(43) Pub. Date: Aug. 17, 2006

(54) Utilization of water-dilutable condensation resin as water-dilutable dispersing agent for pigment concentrates

(75) Inventors: Gerald Hobisch, Graz (AT); Peter Morre, Graz (AT)

Correspondence Address: CONNOLLY BOVE LODGE & HUTZ, LLP, P O BOX 2207, WILMINGTON, DE, 19899, US

(73) Assignee: Cytec Surface Specialites Austria Gmbh, Wendorf (AT)

(21) Appl. No.: 10/565,014

(22) PCT Filed: Jul. 13, 2004
(86) PCT No.: PCT/EP04/07719

§ 371 Date: Jan. 18, 2006

(30) Foreign Application Priority Data
Jul. 23, 2003 (AT) A 1159/2003

(51) Int. Cl. C08G 63/60

(52) U.S. Cl. 524/599

(57) ABSTRACT

The invention relates to the utilization of water-dilutable condensation resin AB as dispersing agent for pigments, wherein the condensation resins have an acid value ranging from 20 mg/g to 180 mg/g and are obtained by condensation of component A containing acid groups with an acid value ranging from 30 mg/g to 240 mg/g, which are selected from amongst the group consisting of copolymers of olefinically unsaturated monomers and by dimerization or oligomerization of compounds obtained from unsaturated aliphatic carboxylic acids and polyesters B containing hydroxyl groups with a hydroxyl value ranging from 20 mg/g to 300 mg/g and a number-average molar mass Mn ranging from 500 g/mol to 5000 g/mol. The mass proportion of components A in the reaction mixture for the synthesis of the condensation resin AB amounts to 30% to 90% and that of component B amounts to 70% to 10%, with the proviso that the sum of the mass proportions of both components always amounts to 100%.

### FIELD OF THE INVENTION

The invention relates to the use of water-dilutable condensation resins as dispersing agents for pigment concentrates.

### BACKGROUND OF THE INVENTION

Dispersing agents for water-dilutable pigment concentrates are often derived from ammonium salts, sulfonium salts or epoxide-amine adducts or contain polyethylene glycol segments. These known dispersing agents have the disadvantage that, because of their ionic or ionogenic structure or due to the polyethylene glycol structures, they are very hydrophilic and thus adversely influence the water resistance and the corrosion protection of coatings. In particular, in a mixture with air-drying alkyd resin systems, there is an incompatibility, leading only to matt, non-glossy coatings.

The object of the invention is therefore to provide a dispersing agent which can be formulated with water-dilutable binders and results in coatings having excellent corrosion protection.

### SUMMARY OF THE INVENTION

It has been found that after neutralization that polymers that contain acid groups and are water-dilutable after neutralisation which are obtainable by condensation of components A containing acid groups and hydrophobic polyesters B containing hydroxyl groups are particularly suitable for dispersing pigment mixtures employed in coatings having excellent corrosion protection.

The invention therefore relates to the use of water-dilutable condensation resins AB as dispersing agents for pigments, wherein the condensation resins have an acid number of from 20 mg/g to 180 mg/g and are obtainable by condensation of components A containing acid groups and having an acid number of from 30 mg/g to 240 mg/g, selected from copolymers of olefinically unsaturated monomers and compounds obtained by dimerisation or oligomerisation of unsaturated aliphatic carboxylic acids, on the one hand, and polyesters B containing hydroxyl groups and having a hydroxyl number of from 20 mg/g to 300 mg/g and a number-average molar mass M, of from 500 g/mol to 5,000 g/mol, the mass fraction of component A in the reaction mixture for the synthesis of the condensation resins AB being from 30% to 90%, and that of component B being 70% to 10%, with the proviso that the sum of the mass fractions of the two components is always 100%.

The acid number is defined according to DIN 53 402 as the quotient of that mass m_{KOH} of potassium hydroxide which is required to neutralise a sample to be analysed and the mass m_{B} of this sample (mass of the solid in the sample in the case of solutions or dispersions); its conventional unit is “mg/g”.

The hydroxyl number is defined according to DIN 53 240 as the quotient of that mass m_{KOH} of potassium hydroxide which has exactly as many hydroxyl groups as a sample to be analysed and the mass m_{B} of this sample (mass of the solid in the sample in the case of solutions or dispersions); its conventional unit is “mg/g”.

Suitable components A are acid group-containing copolymers of olefinically unsaturated monomers having an acid number of the copolymer of from 30 mg/g to 240 mg/g. Such polymers containing acid groups, of the acrylate copolymer type, are described, for example, in EP-A 0 496 079 and in EP-A 0 295 403.

Preferably, such copolymers are prepared in that at least one of the olefinically unsaturated monomers employed, namely A1, carries at least one acid group, preferably a carboxyl group. One or more of these monomers A1 are polymerised together with one or more monomers A2 free of acid groups. It is also possible to change the composition of the monomer mixture during the polymerisation. The desired acid number can be easily established by suitable choice of the nature and amount of the monomers.

Preferably, the acid-group-containing monomers A1 used are α,β-unsaturated carboxylic acids having 3 to 13 carbon atoms or monoalkyl esters of α,β-unsaturated aliphatic dicarboxylic acids having 1 to 20 carbon atoms in the alkyl radical. It is also possible to employ olefinically unsaturated dicarboxylic acids, such as maleic acid, itaconic acid, mesaconic acid, citraconic acid and dihydromuconic acid, in non-esterified form. Suitable unsaturated carboxylic acids are acrylic and methacrylic acid, crotonic and isocrotonic acid, vinylacetic acid, 3-propylacrylic acid and 2-octenoic acid. Suitable monoalkyl esters of unsaturated dicarboxylic acids are monomethyl, monoethyl, monopropyl and monobutyl esters, such as monomethyl maleate, monoethyl fumarate, mesaconic acid monobutyl ester and trans-3-hexenedioic acid monopropyl ester. Preferably, these monomers containing acid groups are employed in mass fractions of from 10% to 33%, based on the mass of the monomer mixture.

The monomers A2 free of acid groups are selected from the alkyl esters of monobasic α,β-unsaturated aliphatic carboxylic acids having 3 to 7 carbon atoms in the acid component and 1 to 20, preferably 1 to 12, carbon atoms in the alkyl component; the dialkyl esters of α,β-unsaturated aliphatic dicarboxylic acids having 4 to 8 carbon atoms in the acid component and 1 to 20, preferably 1 to 12, carbon atoms in the alkyl component; the nitrites of the acids mentioned; the hydroxyalkyl esters of the monobasic α,β-unsaturated aliphatic carboxylic acids mentioned having 3 to 7 carbon atoms in the acid component and 2 to 20 carbon atoms in the hydroxyalkyl component, also including oligo-oxyalkylene glycol mono esters having a number-average degree of polymerisation of from 2 to 50, the alkylene groups of which are selected from the ethylene and 1,2-propylene groups and mixtures thereof; and the vinylaromatics, such as styrene and vinyltoluene and the vinyl esters of saturated aliphatic linear and branched monocarboxylic acids having 2 to 20 carbon atoms, such as vinyl acetate, vinyl propionate and vinyl versatate. The monomers A2 are employed in mass fractions of from 67% to 90%, based on the mass of the monomer mixture of A1 and A2.

Mono- or polyunsaturated fatty acids having 14 to 30 carbon atoms or esters thereof with aliphatic alcohols having 1 to 20 carbon atoms in the alkyl groups can optionally also be employed as further monomers A3. Examples of suitable monomers A3 are oleic acid, linoleic acid, linolenic acid, ricinenic acid and mixtures of such acids, such as safflower oil fatty acid, soya oil fatty acid, linseed oil fatty acid, cottonseed oil fatty acid, sunflower oil fatty acid and tall oil fatty acid and esters thereof. The mass fraction of these monomers A3 in the monomer mixture of A1, A2 and A3 is then 0% to 50%.

The polymerisation of the monomer mixture is carried out by the known methods, preferably by polymerisation initiated by free radicals. Initiators which can be employed are the known peroxides, peracids and derivatives thereof, azo compounds and also the pairs of oxidising and reducing agents known as redox catalysts, also together with salts of transition metals, such as iron, cerium or manganese. The polymerisation can be carried out in solution, emulsion or also in bulk.

The dimerised and oligomerised unsaturated aliphatic carboxylic acids which are likewise suitable as component A are obtained by di- or oligomerisation of mono- or polyunsaturated fatty acids having 6 to 30 carbon atoms. The mixtures of linear branched and cyclic di- and trimers of unsaturated fatty acids having 16 to 24, in particular also 18, carbon atoms, obtained by catalysis with metal oxides are preferred.

Polyesters containing hydroxyl groups and having a hydroxyl number of from 20 mg/g to 300 mg/g and a number-average molar mass of from 500 g/mol to 5,000 g/mol, preferably from 1,000 g/mol to 3,000 g/mol, are suitable as component B. Such polyesters B are obtainable by condensation from
B1 dihydric aliphatic linear, branched or cyclic alcohols having from 2 to 20 carbon atoms, and/or 1,2-epoxides having from 4 to 20 carbon atoms and
B2 mono- or dibasic aliphatic or aromatic carboxylic acids having from 4 to 40 carbon atoms.

Reactive derivatives (esters, anhydrides etc.) of the components B1 and B2 mentioned can also be employed instead of or in a mixture with these components.

An amount-of-substance fraction of up to 10% of component B1 can be replaced here by aliphatic linear, branched or cyclic alcohols having three to 20 carbon atoms which are trihydric or more than trihydric. An amount-of-substance fraction of up to 10% of component B2 can likewise be replaced by a tri- or polybasic aliphatic or aromatic carboxylic acid. The polyesters can also be subjected to condensation with the co-use of mass fractions of up to 15% of hydroxycarboxylic acids B3, which each contain at least one hydroxyl group and at least one carboxyl group.

Alcohols B1 which can be employed are, for example, preferably ethylene glycol, 1,2- and 1,3-propylene glycol, 1,4-butanediol, neopentylglycol, 1,6-hexanediol, 1,2- and 1,4-dihydroxycyclohexane, 3,4-diethyl-3,4-hexanediol and 1,4-bis(hydroxymethyl)cyclohexane, in each case individually or in a mixture. Glycol, neopentylglycol and 1,2-propylene glycol are particularly preferred.

Dibasic carboxylic acids B2 preferably employed are adipic acid, succinic acid, sebacic acid, cyclohexanedicarboxylic acid, phthalic acid, isophthalic acid and terephthalic acid, sulfonyldibenzoic acid, diphenyl ether-dicarboxylic acid and the isomeric naphthalenedicarboxylic acids, and dimeric fatty acids which are obtained by catalysed dimerisation of unsaturated fatty acids (e.g. tall oil fatty acid) as a mixture of acyclic and cyclic dicarboxylic acids. Mono- or polyunsaturated aliphatic dicarboxylic acids, such as maleic acid, fumaric acid, itaconic acid, citraconic acid and mesaconic acid or sorbic acid can also be employed. Adipic acid, maleic acid and the isomeric phthalic acids, in each case individually or in a mixture, are particularly preferred. Suitable monobasic acids are benzoic acid or fatty acids, such as stearic acid.

Suitable hydroxycarboxylic acids B3 are lactic acid, dimethylolpropionic acid, tartaric acid, racemic tartaric acid, glycolic acid, dihydroxysuccinic acid and malic acid. This component can also comprise mixtures of several of the suitable substances.

The polyesters are obtained in a known manner by polycondensation of the educts B1 to B3 or their ester-forming derivatives (such as methyl esters or halides or anhydrides of the acids or acetates of the alcohols) in bulk or in solution. The known transesterification catalysts can be employed to accelerate the reaction.

The resins AB according to the invention are obtainable by reaction of components A and B at elevated temperature, preferably at 100° C. to 220° C., preferably in the melt without addition of a solvent, but it is also possible optionally to add a solvent which is inert under the reaction conditions in mass fractions of up to 20%, based on the sum of the masses of components A and B and of the solvent. The reaction is carried out until the acid number of the condensation product of A and B has reached a value of from 20 mg/g to 180 mg/g. During the condensation reaction, small amounts of water are formed which escape at the reaction temperature. The water can preferably also be removed by azeotropic distillation by employing a solvent which is immiscible with water and forms an azeotrope with water.

The resins AB prepared in this way are neutralised with aqueous alkalis, preferably ammonia solutions or amines, optionally after addition of small amounts of a water-dilutable solvent. In this context, the amount of alkalis is chosen so that at least half of the acid groups of the resin are neutralised. Preferably, however, the neutralisation is complete. The mixture is then diluted further to a solids mass fraction of preferably from 20% to 60%, particularly preferably from 30% to 50%, by addition of water. It is also possible to adjust the concentration of the neutralising agent so that dilution and neutralisation are carried out simultaneously. An aqueous solution or dispersion of the neutralised resin is obtained in this way.

The resins AB prepared according to the invention are water-dilutable after neutralisation. They are excellently suitable as dispersing agents for the preparation of low-solvent and solvent-free pigment pastes. They have a high pigment-binding capacity, are stable to storage and do not change or do not substantially change their viscosity during storage in the pigment pastes prepared therefrom. These pigment pastes can readily be incorporated into aqueous binders. Compared with directly pigmented paints, the paint properties are not adversely influenced.

Depending on the nature of the pigment employed, pigment concentrates can be prepared with the resins used according to the invention; in the case of inorganic pigments, 100 g of the pigment concentrate comprise from 40 g to 70 g of pigment, from 5 g to 20 g of the condensation resin, optionally up to 10 g of a wetting agent and up to 10 g of a solvent; in the case of organic pigments, 100 g of the pigment concentrate comprise from 20 g to 40 g of the pigment, from 5 g to 40 g of the condensation resin and optionally up to 10 g of a wetting agent and up to 10 g of a solvent; in the case of pigment concentrates containing carbon black, the composition per 100 g of the concentrate is advantageously from 15 g to 30 g of carbon black, from 10 g to 30 g of the condensation resin, optionally up to 10 g of a wetting agent and up to 10 g of a solvent. In this context, the concentrate is in each case topped up to the total mass of 100 g by addition of water.

The following examples explain the invention, without limiting it in its scope.

In the following examples, as in the preceding text, all data with the unit “%” are mass fractions, unless stated otherwise. “Parts” are always parts by mass. Concentration data in “%” are mass fractions of the dissolved substance in the solution.

### EXAMPLES

1 Preparation of Copolymers AI to AIV and Polyesters BV and BVI

1.1 Preparation of Copolymer AI

30 parts of linseed oil fatty acid and 5 parts of xylene were heated to 135° C. to 140° C. A mixture of 32 parts of isobutyl methacrylate, 6 parts of tert-butyl perbenzoate, 1 part of dibenzoyl peroxide (50% strength on dicyclohexyl phthalate as a support) and 5 parts of xylene was simultaneously added uniformly at this temperature in the course of 6 to 8 hours. When the addition had ended, the reaction temperature was maintained until a residue determination gave a polymerisation conversion of at least 95%. The copolymer had an acid number of 209 mg/g and a Staudinger index (in dimethylformamide as the solvent) of 5.5 cm³/g.

1.2 Preparation of Copolymers AII to AIV

Copolymers AII to AIV were prepared in a known manner by solution polymerisation in isopropanol corresponding to a calculated mass fraction of solids of 50%. The quantity ratios of the monomers employed and the characteristic values of the copolymers obtained are summarised in Table 1.

TABLE 1
Composition of the copolymers

| | | Copolymer A | | | |
|---|---|---|---|---|---|
| | | AI | AII | AIII | AIV |
| (A2) | Ethyl acrylate | — | — | — | 25 |
| | Butyl acrylate | — | — | — | 30 |
| | 2-Ethylhexyl acrylate | — | 25 | 30 | — |
| | Methyl methacrylate | — | — | — | 30 |
| | Isobutyl methacrylate | 32 | 18 | 27 | — |
| | Styrene | — | 26 | 18.5 | — |
| | Vinyltoluene | 6 | — | — | — |
| (A1) | Acrylic acid | — | 31 | — | 15 |
| | Methacrylic acid | 21 | — | 24.5 | — |
| (A3) | Linseed oil fatty acid | 41 | — | — | — |
| | Acid number in mg/g | 209 | 241 | 160 | 117 |

The figures given for the substances employed are mass fractions in %, which add up to 100% in each case.

1.3 Preparation of Polyesters BV and BVI (Component B)

Polyesters BV and BVI were prepared by azeotropic condensation with the addition of approx. 50 g toluene as the entraining agent. The condensation was carried out until the acid number had fallen below 5 mg/g. The composition of the polyesters (masses in g employed for the polycondensation) can be seen from Table 2.

TABLE 2
Composition of the polyesters

| | Polyester BV | Polyester BVI |
|---|---|---|
| Trimethylolpropane | 118.0 | 118.0 |
| Neopentylglycol | 13.6 | 13.6 |
| Phthalic anhydride | — | 391.0 |
| Adipic acid | 100.0 | — |
| Linseed oil fatty acid | 196.0 | — |
| Cardura E 10 | — | 600.0 |
| Hydroxyl number in mg/g | 93.0 | 112.0 |

2 Preparation of the Condensation Resins (Dispersing Agents D1 to D7)

### Examples 2.1 to 2.7

The copolymers A and the polyesters B were introduced into a suitable reaction vessel in the ratios of amounts according to Table 3. The batch was gradually brought to a circulation temperature of 200° C., while stirring, and was kept at this temperature until the stated acid number was reached. After removal of the solvent, the batch was adjusted to a mass fraction of solids of 87% with ethylene glycol monobutyl ether and emulsified in water at 50° C. with addition of N,N-dimethylethanolamine. The amount of amine and water was chosen such that a pH of the emulsion of from 8.2 to 8.8 and a mass fraction of solids of 35% resulted. The solutions of the dispersing agents prepared in this way were milky to transparent liquids.

TABLE 3
Preparation of the condensation resins AB
(all data relating to the quantities of starting products are mass
fractions of the components in the solid matter, and the sum is 100%)

| | Example | | | | | | |
|---|---|---|---|---|---|---|---|
| | 2.1 | 2.2 | 2.3 | 2.4 | 2.5 | 2.6 | 2.7 |
| Dispersing | D1 | D2 | D3 | D4 | D5 | D6 | D7 |
| agent | | | | | | | |
| Copolymer A | AI | AII | AIII | AIV | AI | AII | AIV |
| | 60 | 50 | 90 | 80 | 70 | 65 | 75 |
| Polyester B | BV | BVI | BV | BVI | BVI | BV | BV |
| | 40 | 50 | 10 | 20 | 30 | 35 | 25 |
| Acid number | 91 | 68 | 135 | 73 | 115 | 126 | 68 |
| in mg/g | | | | | | | |

3 Paint Property Testing of the Condensation Products as Dispersing Agents for Pigments

In accordance with the data in Table 4, the stated quantities of the particular pigments were dispersed in the following dispersing agent formulation on a bead mill and the formulations were then subjected to testing of their storage stability.

| | |
|---|---|
| 250.0 | parts of dispersing agent from the examples given, 35% |
| | strength in water |
| 22.0 | parts of Additol ® VXW 6374 (wetting agent) |
| 4.0 | parts of Additol ® VXW 4973 (defoamer) |
| 77.0 | parts of water |
| 353.0 | parts of pigment paste formulation |

TABLE 4
Pigment pastes

| | | | | Viscosity | Viscosity | |
|---|---|---|---|---|---|---|
| | | Dis- | | after 1 | after 1 | Stor- |
| | | persing | Pigment | day in | month in | age |
| Pigment | | agent | (parts) | mPa · s | mPa · s | test |
| P1 | ®Hostaperm | D1 | 88.0 | 580 | 460 | OK |
| | Yellow H4G | | | | | |
| P2 | ®Novoperm | D2 | 80.0 | 504 | 920 | OK |
| | Orange HL70 | | | | | |
| P3 | ®Hostaperm | D3 | 40.0 | 500 | 560 | OK |
| | Pink E | | | | | |
| P4 | ®Hostaperm | D4 | 80.0 | 595 | 616 | OK |
| | Green 8G | | | | | |
| P5 | ©KRONOS | D1 | 260.0 | 1,030 | 1,320 | OK |
| | 2310 | | | | | |
| P6 | ©Bayferrox | D6 | 260.0 | 1,100 | 1,580 | SS |
| | 130BM | | | | | |
| P7 | ®Printex U | D7 | 30.0 | 207 | 230 | OK |
| P8 | ©Paliotol | D5 | 80.0 | 580 | 710 | OK |
| | Yellow L2140 | | | | | |
| | HD | | | | | |
| P9 | ©Paliotol | D2 | 80.0 | 530 | 503 | OK |
| | Red L3910 HD | | | | | |
| P10 | ©Heliogen | D4 | 50.0 | 280 | 296 | OK |
| | Green L8730 | | | | | |

Pigment from Clariant Deutschland GmbH (1-4)
Pigment from Kronos Titan (5)
Pigment from Bayer AG (6)
Pigment from Degussa AG (7)
Pigment from BASF AG (8-10)
Storage test: Storage at room temperature for 3 months
OK: in order;
SS: slight sediment

It can be seen that the pastes prepared with the dispersing agents according to the invention are storage-stable and have a high pigment-binding capacity.

4 Paint Testing

With pigment paste P2 and pigment paste P5, paints were prepared with various aqueous binders in the ratio of the mass of the pigment (m_{P}) to the mass of the binder (m_{B}) given in Table 5.

TABLE 5
Paints

Paint no.

| | L1 | L2 | L3 | L4 | L5 | L6 |
|---|---|---|---|---|---|---|
| Binder | a | b | c | d | b | a |
| Pigment paste | P5 | P5 | P2 | P5 | P2 | P2 |
| m_{P}/m_{B} | 1:1 | 1:1 | 0.2:1 | 1:1 | 0.2:1 | 0.2:1 |

Binder a is an oxidatively drying, acrylic-modified alkyd resin in aqueous emulsion form (®Resydrol AY 586 w, Cytec Surface Specialties Austria GmbH),
Binder b is an oxidatively drying, ammonia-neutralised acrylic-alkyd hybrid system in aqueous emulsion form (®Resydrol VAY 6278 w, Cytec Surface Specialties Austria GmbH),
Binder c is an epoxy resin-modified, non-drying alkyd resin which is water-dilutable after neutralisation with amine (®Resydrol AX 246 w, Cytec Surface Specialties Austria GmbH),
Binder d is a hydroxy-functional, amine-neutralised acrylic resin emulsion for two-pack polyurethane systems (®Macrynal VSM 6285w, Cytec Surface Specialties Austria GmbH).

Steel sheets were coated with these paints in a wet film thickness of 150 im.

On the test sheets of the oxidatively drying paints, gloss and haze were determined with a gonioreflectometer from BYK after storage at room temperature (RT, 23° C.) for 48 hours, and the König pendulum hardness (DIN 53157) was determined after storage at room temperature for one and seven days after application. The mechanical stability of the coatings was evaluated on a dry layer thickness of from 30 μm to 35 μm after storage at RT for 7 days by indentation testing in accordance with DIN EN ISO 1520 and by impact testing in accordance with ASTM D 2794.

The test sheets based on the stoving types (®Resydrol AX 246) were air-dried for 10 minutes after the application, dried at 80° C. for 10 minutes and then stoved at 130° C. for 20 minutes. The tests were carried out one hour after the stoving.

The test sheets based on the two-pack polyurethane types (®Macrynal VSM 6285w) were air-dried for 10 minutes after the application and then force-dried at 80° C. for 30 minutes. The tests were carried out the next day.

As a comparison, in each case a steel sheet which was coated with a directly pigmented comparison paint C1 to C5 (without dispersing agent) of the same binder was used. The results of the paint testing are summarised in Table 6.

TABLE 6
Paint testing

| Test | Gloss | | Pendulum hardness in s | | Mechanical |
|---|---|---|---|---|---|
| paint | (20°) | Haze | after 1 d | after 7 d | test |
| L1 | 72 | 2.16 | 24 | 38 | 0 |
| C1 | 66 | 2.22 | 24 | 38 | |
| L2 | 59 | 2.16 | 34 | 34 | 0 |
| C2 | 54 | 2.12 | 30 | 34 | |
| L3* | 61 | 2.34 | 126 | not determined | + |
| C3* | 52 | 2.38 | 139 | not determined | |
| L4 | 82 | 2.09 | 138 | 136 | 0 |
| C4 | 81 | 2.14 | 146 | 146 | |
| L5 | 89 | 2.68 | 36 | 36 | 0 |
| C5 | 88 | 2.59 | 40 | 39 | |

0: no difference between the L and C samples
+: L sample is up to 10% better in the test than C sample
++: L sample is more than 10% better in the test than C sample
−: L sample is up to 10% poorer in the test than C sample
−−: L sample is more than 10% poorer in the test than C sample

Testing of the Corrosion Resistance

The corrosion resistance was judged by storage in water at 40° C. in accordance with ISO 2812 T2, by humidity cabinet resistance (test under tropical conditions) in accordance with DIN 53210 and by the salt spray mist test in accordance with DIN EN ISO 7253 in an anticorrosion primer based on an aqueous epoxy-acrylic resin hybrid emulsion (®Resydrol VAX 6267w, Cytec Surface Specialties Austria GmbH).

Procedure: The required amount of the dispersing agent was added to the pigment mixture of the grinding batch in order to achieve a readily grindable consistency of the paste. If necessary, the viscosity was adjusted by addition of further water. The pigment-containing mixture was dispersed in a dissolver for 30 minutes, the primer formulation was then finished with the paint completion mixture, and the mixture was homogenized for 10 minutes and if necessary adjusted to a viscosity of from 80 mPa·s to 120 mPa·s with a further amount of water.

TABLE 7
Paint formulation for the corrosion test

| Grinding batch: | | | |
|---|---|---|---|
| Water | 10 | parts | |
| Dispersing agent | see below | | |
| ®Bayferrox 130 FS | 12.6 | parts | pigment 1) |
| ®Heucophos ZPZ | 38.1 | parts | active pigment 2) |
| ®Setacarb OG | 27.7 | parts | pigment 3) |
| ®Talkum AT extra | 17.8 | parts | pigment 4) |
| ®Additol XW 372 | 0.75 | part | defoamer 5) |
| Paint completion mixture: | | | |
| ®Additol VXW 6388 | 0.8 | part | PU thickener 5) |
| ®Resydrol VAX 6267 | 217.5 | parts | 5) |

Manufacturers:
1) Bayer AG,
2) Heubach,
3) Omya GmbH,
4) Norwegian Talc,
5) Cytec Surface Specialties Austria GmbH

Dispersing Agents Tested:

Dispersing agent D1 according to the invention (20 parts, 35% strength) from Example 2.1 was used for the testing.

For Comparison C1, grinding is carried out directly in the binder (70 parts, 40% strength), the dispersing being carried out on a bead mill (duration 1 hour) in order to achieve an adequate dispersing result.

Comparison C2 is an anionic dispersing agent based on acrylate (10 parts, 35% strength; ®Orotan 681, Rohm & Haas).

Comparison C3 is a polyether-modified dispersing agent (8.8 parts, 40% strength, (®Byk 190, Byk).

For the storage in water and the humidity cabinet test, 150 im wet films are drawn on EC bonder sheets, drying time before storage in water was 24 hours, and the humidity cabinet test was carried out after a drying time of 1 week. For the salt spray test (DIN EN ISO 7253), the primer was applied to a coated EC bonder sheet and, after drying for one week, cross-cut and tested.

Results:

The results are summarised in Table 8.

TABLE 8
Results of the corrosion test

| | | Humidity cabinet | |
|---|---|---|---|
| Sample | Storage in water | test | Salt spray test |
| Example E1 | ++ | ++ | + |
| Comparison C1 | 0 | 0 | 0 |
| Comparison C2 | −− | − | 0 |
| Comparison C3 | − | −− | |

Rating plan:
0: no difference between sample and C1 samples
+: sample is up to 10% better in the test than C1 sample
++: sample is more than 10% better in the test than C1 sample
−: sample is up to 10% poorer in the test than C1 sample
−−: sample is more than 10% poorer in the test than C1 sample

It can be seen from these results that it is possible, with the dispersing agents according to the invention, to prepare a series of the most diverse low-solvent pigment pastes and to pigment corrosion-resistant paints with an excellent result, without adversely influencing the performance properties of the paints.

1. A method of use of water-dilutable condensation resins AB as dispersing agents for pigments, comprising mixing the said pigments and the said condensation resins AB, wherein the condensation resins have an acid number of from 20 mg/g to 180 mg/g and are obtainable by condensation of components A containing acid groups and having an acid number of from 30 mg/g to 240 mg/g, chosen from copolymers of olefinically unsaturated monomers and compounds obtained by dimerization or oligomerization from unsaturated aliphatic carboxylic acids, on the one hand, and polyesters B containing hydroxyl groups and having a hydroxyl number of from 20 mg/g to 300 mg/g and a number-average molar mass M, of from 500 g/mol to 5,000 g/mol, and the mass fraction of component A in the reaction mixture for the synthesis of the condensation resins AB is 30% to 90% and that of component B is 70% to 10%, with the proviso that the sum of the mass fractions of the two components always gives 100%.

2. The method of use of claim 1, characterised in that a copolymer which is obtainable by joint polymerisation of monomers A1 containing acid groups and unsaturated monomers A2 without acid groups is employed as the component A containing acid groups.

3. The method of use of claim 1, characterised in that the monomers A1 containing acid groups are chosen from alpha,beta-unsaturated carboxylic acids having 3 to 13 carbon atoms and monoalkyl esters of unsaturated dicarboxylic acids having from 1 to 20 carbon atoms in the alkyl radical.

4. The method of use of claim 1, characterised in that the mass fraction of the monomers A1 in the mixture of monomers A1 and A2 is from 10% to 33%.

5. The method of use of claim 1, characterised in that the polyesters B containing hydroxyl groups are polycondensates of dihydric aliphatic alcohols B1 and aliphatic or aromatic carboxylic acids B2.

6. The method of use of claim 1, characterised in that the condensation resins AB are neutralised and dispersed in water before the mixing with pigments.

7. The method of use of claim 1, characterised in that the condensation resins AB are mixed with pigments in a mass ratio of from 30 g to 300 g of pigment to 100 g of the condensation resin.
